(19) United States
(12) Patent Application Publication
(10) Pub. No.: US 2007/0033222 A1
(43) Pub. Date: Feb. 8, 2007

(54) Process and system for storing managing displaying and protecting multimedia contents on external storage units

(75) Inventor: Antonino Valenti, Lainate (IT)

Correspondence Address: R Ruschena Patent Agent, 7900 E Union Avenue, Suite 1100, Denver, CO, 80237, US

(73) Assignee: SUPERSONICA S. r. l.

(21) Appl. No.: 10/558,653

(22) PCT Filed: Dec. 2, 2003
(86) PCT No.: PCT/IT03/00795

§ 371 Date: Nov. 29, 2005

(51) Int. Cl. G06F 7/00

(52) U.S. Cl. 707/104.1; 707/1

(57) ABSTRACT

A process and a system are disclosed for storing, managing, displaying and protecting multimedia contents on external storage units (1); the system comprises: at least one external storage unit (1) composed of a support body (2) with a central unit, and of an interface (3) for a communication port of a computer (7); data bases with miscellaneous multimedia contents, resident in or being adapted to be loaded in the storage unit (1); and an integrated managing program, residing in the storage unit (1), for storing, managing, displaying and protecting the data bases with multimedia contents.

The present invention refers to a process and a system for storing, managing, displaying and protecting multimedia contents on external storage units, of the Universal Serial Bus (U.S.B.) or other communication protocols.

Recently, portable external storage units have been developed, whose sizes are very small and whose capacity is high, adapted to be connected to personal computers through their U.S.B. port. The applications of such storage units however so far have been limited on one hand to provide a cryptographic key for enabling programs to be executed on personal computers themselves, and on the other hand to store data in order to be able to move them, together with a user, to different places or computers.

Applications like the one object of the present invention, instead, are not present in the prior art.

Object of the present invention is providing a process and a system that allow, in a simple but efficient way, to store, manage, display and protect multimedia contents being present on storage units of the above-mentioned type.

Further characteristics of the present invention are as follows:

total integration: the whole system is residing in the storage unit;

multi-platform (Windows®/MacOS®) compatibility;

immediate use: it is enough to connect the inventive system to a U.S.B. (or other format) port of a computer in order to immediately display its contents without needing any installation (apart from the update of some system files when necessary);

immediate transferability of the same inventive system from computer to computer to be used in different environments;

capability of updating or replacing the contents through Internet;

capability of purchasing new contents through Internet;

capability of updating the managing software through Internet;

contents-protecting system that is “transparent” for the user: no codes, passwords or hardware keys of any type are required for operating the inventive system with the provided multimedia contents. Only in order to download through Internet new multimedia files or updates, the user will be required to have a password and a user identification (that will be assigned to him) to be used upon purchasing to receive the license number of the downloaded multimedia file. The managing software integrated in the inventive system will then take care to import the downloaded files requiring only once their related license numbers for their validation.

The above and other objects and advantages of the invention, as will appear from the following description, are obtained by a process and a system as claimed in the independent Claims. Preferred embodiments and non-trivial variations of the present invention are claimed in the dependent Claims.

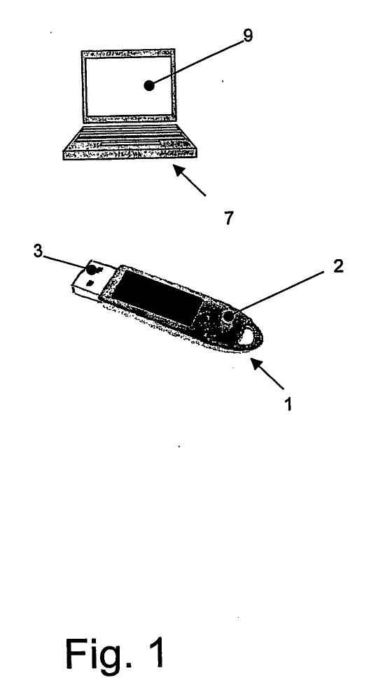

The present invention will be better described by some preferred embodiments thereof, given as a non-limiting example, with reference to the enclosed drawings, in which the only FIG. 1 is a schematic perspective view of an external storage unit adapted to be used in the system of the present invention.

Herein below, a preferred, but not limiting, embodiment of the process and the system of the present invention is shown. They will be described herein below as applied to the field of supplying multimedia learning courses, but it is obvious that they can find a valid and efficient application to any field in which it is necessary to store, manage, display and protect data contained in portable external storage units.

According to the Figure, the system of the present invention substantially comprises:

at least one external storage unit 1 composed of a support body 2 in which a central unit (not shown) is provided, and of an interface 3 for a communication port of a computer 7, for example of the U.S.B. type (or another similar format, such as USB2, Firewire (IEEE 1394), Smart Media, Flash RAM, ecc.);

data bases with miscellaneous multimedia contents (residing in the central unit of the storage unit 1 or to be loaded in various ways, for example through Internet, etc.); and

an integrated managing program, residing in the central unit of the storage unit 1, for storing, managing, displaying and protecting the above-mentioned multimedia contents.

In order to perform the step of storing (adding) the multimedia contents, the inventive system substantially performs the following steps:

downloading additional multimedia contents as a file through Internet (or similar supports) together with a licence number;

connecting the system to the computer 7 through a port of the U.S.B. type or another type;

automatically displaying, by the computer 7, an icon of the storage unit 1 on a desktop of its display 9;

activating an update mechanism by operating (for example by double-clicking) on an icon of the multimedia contents file;

automatically performing, by the system managing software, necessary protection checks, a request for the licence number and a copy of the multimedia file of the system storage unit 1; and

displaying, by the managing software, the main screen, with an already updated pop-up index, containing titles of added multimedia files.

In order to perform the step of managing (updating) the multimedia contents, the inventive system will substantially perform the following steps:

downloading additional multimedia contents as a file through Internet (or similar supports) together with a licence number;

connecting the system to the computer 7 through a port of the U.S.B. type or another type;

automatically displaying, by the computer 7, an icon of the storage unit 1 on a desktop of its display 9;

activating an update mechanism by operating (for example by double-clicking) on an icon of the multimedia contents file;

automatically performing, by the system managing software, necessary protection checks, a request for the licence number and a copy of the multimedia file of the system storage unit 1; and

updating the copied multimedia file, said updated file being modified in its title and its contents according to what is provided by the update file.

In order to perform the step of displaying the multimedia contents, the inventive system will substantially perform the following steps:

connecting the system to the computer 7 through a port of the U.S.B. type or of another type;

automatically displaying, by the computer 7, the system icon on a desktop of its display 9;

manually opening a folder of the storage unit 1 by operating (for example by double-clicking the mouse) on a corresponding icon;

executing the managing software by operating (for example by double-clicking the mouse) on a related icon inside the folder; and

displaying, by the managing software, a pop-up index for selecting the multimedia material residing in the system memory 1.

In order to perform the step of protecting the multimedia contents, the inventive system will substantially perform the following steps:

preparing the storage units 1 with special serial numbers;

coupling the multimedia files with specific license numbers;

customising the multimedia files with serial numbers of those storage units 1 in which they will be transferred;

verifying, by the managing software, that all elements correspond before integrating data in the storage unit 1; and

integrating, by the managing software, inside the storage unit 1, multimedia files that had been previously downloaded through a browser.

The step of verifying, by the managing software, for managing the multimedia contents, comprises the following checks:

the storage unit 1 support, in which the managing software is located, must be of a removable type;

the managing software name must correspond with the name contained inside the managing software;

the name of the removable support of the storage unit 1 must correspond with the name contained inside the managing software;

inside the removable software of the storage unit 1 a crypted file containing the license number must be present, called for example “licence.dll”; and

the serial number inside the crypted file with the license number must correspond with the serial number of the removable support of the storage unit 1.

The step of verifying, by the managing software, for displaying the multimedia contents, comprises the following checks:

the multimedia file extension must be correct;

the multimedia file header must be correct;

the multimedia file format must be correct;

the multimedia file must be inside its related folder on the removable support of the inventive system, in which the managing software can also be found;

inside the crypted file with the license number, name and number of licence of use of the multimedia file must be found: otherwise the managing software activates a displaying mode that is closed after a predetermined period of time;

the multimedia file must contain the same number of licence of use that is present inside the crypted file with license number;

the multimedia file must contain the same serial number of the removable support of the system in which it is present; and

the multimedia file name must correspond with the name contained inside the managing software.

The step of verifying, by the managing software, for adding the multimedia contents, comprises the following checks:

the multimedia file extension must be correct;

the multimedia file header must be correct;

the multimedia file format must be correct;

the multimedia file must never have been previously credited; the multimedia file, therefore, must not contain license numbers;

the license number used for displaying must never have been previously used, therefore it must not be present inside the crpyted file with the license number; and
the license number used for displaying must have been generated depending on user password and serial number of the removable support of the inventive system, through a specific algorithm.

With the above-described inventive process and system, the following advantages are obtained:
distribution and use of multimedia material;
as regards the manufacturer, transparent (low cost) protection of contents;
as regards the manufacturer too, regeneration of stocks (the contents can be updated or replaced);
as regards the consumer, user friendliness (no installation is required);
always from the consumer's point of view, transportability (the contents can be instantaneously seen on any computer), and updatability (the contents can be updated).

1. System for storing, managing, displaying and protecting multimedia contents on external storage units (1), characterised in that it comprises:
at least one external storage unit (1) composed of a support body (2) in which a central unit is provided, and of an interface (3) for a communication port of a computer (7);
data bases with miscellaneous multimedia contents, said data bases being resident in said central unit of said storage unit (1) or being adapted to be loaded in said storage unit (1) in various ways; and
an integrated managing program, residing in said central unit of said storage unit (1), for storing, managing, displaying and protecting said data bases with multimedia contents.

2. System according to claim 1, characterised in that said communication interface (3) of said external storage units (1) is of the U.S.B. (Universal Serial Bus) type.

3. System according to claim 1, characterised in that said communication interface (3) of said external storage units (1) is of the U.S.B.2, Firewire (IEEE 1394), Smart Media or Flash RAM type.

4. System according to claim 1, characterised in that said managing program performs the step of storing said data bases with multimedia contents through the following steps:
downloading additional multimedia contents as a file through Internet (or similar supports) together with a licence number;
connecting the system to the computer (7) through a port of the U.S.B. type or another type;
automatically displaying, by the computer (7), an icon of the storage unit (1) on a desktop of its display (9);
activating an update mechanism by operating on an icon of the multimedia contents file;
automatically performing, by the system managing software, necessary protection checks, a request for the licence number and a copy of the multimedia file of the system storage unit (1); and
displaying, by the managing software, the main screen, with an already updated pop-up index, containing titles of added multimedia files.

5. System according to claim 1, characterised in that said managing program performs the step of managing said data bases with multimedia contents through the following steps:
downloading additional multimedia contents as a file through Internet (or similar supports) together with a licence number;
connecting the system to the computer (7) through a port of the U.S.B. type or another type;
automatically displaying, by the computer (7), an icon of the storage unit (1) on a desktop of its display (9);
activating an update mechanism by operating on an icon of the multimedia contents file;
automatically performing, by the system managing software, necessary protection checks, a request for the licence number and a copy of the multimedia file of the system storage unit (1); and
updating the copied multimedia file, said updated file being modified in its title and its contents according to what is provided by the update file.

6. System according to claim 1, characterised in that said managing program performs the step of displaying said data bases with multimedia contents through the following steps:
connecting the system to the computer (7) through a port of the U.S.B. type or of another type;
automatically displaying, by the computer (7), the system icon on a desktop of its display (9);
manually opening a folder of the storage unit (1) by operating on a corresponding icon;
executing the managing software by operating on a related icon inside the folder; and
displaying, by the managing software, a pop-up index for selecting the multimedia material residing in the system memory (1).

7. System according to claim 1, characterised in that said managing program performs the step of protecting said data bases with multimedia contents through the following steps:
preparing the storage units (1) with special serial numbers;
coupling the multimedia files with specific license numbers;
customising the multimedia files with serial numbers of those storage units (1) in which they will be transferred;
verifying, by the managing software, that all elements correspond before integrating data in the storage unit (1); and
integrating, by the managing software, inside the storage unit (1), multimedia files that had been previously downloaded through a browser.

8. System according to claim 7, characterised in that the step of verifying, by the managing software, for managing the multimedia contents, comprises the following checks:
a storage unit (1) support, in which the managing software is located, must be of a removable type;
the managing software name must correspond with the name contained inside the managing software;
the name of the removable support of the storage unit (1) must correspond with the name contained inside the managing software;
inside the removable software of the storage unit (1) a crypted file containing the license number must be present; and
the serial number inside the crypted file; with the license number must correspond with the serial number of the removable support of the storage unit (1).

9. System according to claim 7, characterised in that the step of verifying, by the managing software, for displaying the multimedia contents, comprises the following checks:
the multimedia file extension must be correct;
the multimedia file header must be correct;
the multimedia file format must be correct;
the multimedia file must be inside its related folder on the removable support of the system, in which the managing software can also be found;
inside the crypted file with the license number, name and number of licence of use of the multimedia file must be found: otherwise the managing software activates a displaying mode that is closed after a predetermined period of time;
the multimedia file must contain the same number of licence of use that is present inside the crypted file with license number;
the multimedia file must contain the same serial number of the removable support of the system in which it is present; and
the multimedia file name must correspond with the name contained inside the managing software.

10. System according to claim 7, characterised in that the step of verifying, by the managing software, for adding the multimedia contents, comprises the following checks:
the multimedia file extension must be correct;
the multimedia file header must be correct;
the multimedia file format must be correct;
the multimedia file must never have been previously credited; the multimedia file, therefore, must not contain license numbers;
the license number used for displaying must never have been previously used, therefore it must not be present inside the crpyted file with the license number; and
the license number used for displaying must have been generated depending on user password and serial number of the removable support of the system, through a specific algorithm.

11. Process for storing data bases with multimedia contents stored in external storage units (1), said process comprising the steps of:
downloading additional multimedia contents as a file through Internet (or similar supports) together with a licence number;
connecting the system to the computer (7) through a port of the U.S.B. type or another type;
automatically displaying, by the computer (7), an icon of the storage unit (1) on a desktop of its display (9);
activating an update mechanism by operating on an icon of the multimedia contents file;
automatically performing, by the system managing software, necessary protection checks, a request for the licence number and a copy of the multimedia file of the system storage unit (1); and
displaying, by the managing software, the main screen, with an already updated pop-up index, containing titles of added multimedia files.

12. Process for managing data base with multimedia contents stored in external storage units (1), said process comprising the steps of:
downloading additional multimedia contents as a file through Internet (or similar supports) together with a licence number;
connecting the system to the computer (7) through a port of the U.S.B. type or another type;
automatically displaying, by the computer (7), an icon of the storage unit (1) on a desktop of its display (9);
activating an update mechanism by operating on an icon of the multimedia contents file;
automatically performing, by the system managing software, necessary protection checks, a request for the licence number and a copy of the multimedia file of the system storage unit (1); and
updating the copied multimedia file, said updated file being modified in its title and its contents according to what is provided by the update file.

13. Process for displaying data bases with multimedia contents stored in external storage units (1), said process comprising the steps of:
connecting the system to the computer (7) through a port of the U.S.B. type or of another type;
automatically displaying, by the computer (7), the system icon on a desktop of its display (9);
manually opening a folder of the storage unit (1) by operating on a corresponding icon;
executing the managing software by operating on a related icon inside the folder; and
displaying, by the managing software, a pop-up index for selecting the multimedia material residing in the system memory (1).

14. Process for protecting data bases with multimedia contents stored in external storage units (1), said process comprising the steps of:
preparing the storage units (1) with special serial numbers;
coupling the multimedia files with specific license numbers;
customising the multimedia files with serial numbers of those storage units (1) in which they will be transferred;
verifying, by the managing software, that all elements correspond before integrating data in the storage unit (1); and
integrating, by the managing software, inside the storage unit (1), multimedia files that had been previously downloaded through a browser.

15. Process according to claim 14, characterised in that the step of verifying, by the managing software, for managing the multimedia contents, comprises the following checks:
a storage unit (1) support, in which the managing software is located, must be of a removable type;
the managing software name must correspond with the name contained inside the managing software;
the name of the removable support of the storage unit (1) must correspond with the name contained inside the managing software;
inside the removable software of the storage unit (1) a crypted file containing the license number must be present; and
the serial number inside the crypted file with the license number must correspond with the serial number of the removable support of the storage unit (1).

16. Process according to claim 14, characterised in that the step of verifying, by the managing software, for displaying the multimedia contents, comprises the following checks:
the multimedia file extension must be correct;
the multimedia file header must be correct;
the multimedia file format must be correct;
the multimedia file must be inside its related folder on the removable support of the system, in which the managing software can also be found;
inside the crypted file with the license number, name and number of licence of use of the multimedia file must be found: otherwise the managing software activates a displaying mode that is closed after a predetermined period of time;
the multimedia file must contain the same number of licence of use that is present inside the crypted file with license number;
the multimedia file must contain the same serial number of the removable support of the system in which it is present; and
the multimedia file name must correspond with the name contained inside the managing software.

17. Process according to claim 14, characterised in that the step of verifying, by the managing software, for adding the multimedia contents, comprises the following checks:
the multimedia file extension must be correct;
the multimedia file header must be correct;
the multimedia file format must be correct;
the multimedia file must never have been previously credited; the multimedia file, therefore, must not contain license numbers;
the license number used for displaying must never have been previously used, therefore it must not be present inside the crpyted file with the license number; and
the license number used for displaying must have been generated depending on user password and serial number of the removable support of the system, through a specific algorithm.
